(19) United States
(12) Patent Application Publication
(10) Pub. No.: US 2013/0282549 A1
(43) Pub. Date: Oct. 24, 2013

(54) COMPUTERIZED APPARATUS FOR ENHANCED TRANSMISSION OF ORDERS AND MARKET DATA BETWEEN TRADERS AND ONE OR MORE EXCHANGES

(71) Applicant: Edward R. Howorka, Denville, NJ (US)

(72) Inventor: Edward R. Howorka, Denville, NJ (US)

(73) Assignee: MarketFactory, Inc., New York, NY (US)

(21) Appl. No.: 13/655,482

(22) Filed: Oct. 19, 2012

Related U.S. Application Data
(63) Continuation-in-part of application No. 13/562,287, filed on Jul. 30, 2012.
Application No. 13/562,287 is a continuation-in-part of application No. 13/225,331, filed on Sep. 2, 2011, now abandoned.
Application No. 13/225,331 is a continuation-in-part of application No. 13/007,562, filed on Jan. 14, 2011, now abandoned.
Application No. 13/007,562 is a continuation-in-part of application No. 12/715,368, filed on Mar. 1, 2010, now abandoned.
Application No. 12/715,368 is a continuation-in-part of application No. 12/536,460, filed on Aug. 5, 2009, now abandoned.
Application No. 12/536,460 is a continuation-in-part of application No. 12/357,394, filed on Jan. 22, 2009, now abandoned.
Application No. 12/357,394 is a continuation-in-part of application No. 12/357,398, filed on Jan. 22, 2009, now Pat. No. 8,296,217.
(60) Provisional application No. 61/083,276, filed on Jul. 24, 2008.
(60) Provisional application No. 61/022,701, filed on Jan. 22, 2008.

(51) Int. Cl. G06Q 40/04

(52) U.S. Cl. CPC G06Q 40/04
USPC 705/37

(57) ABSTRACT

An automated market data distribution system uses proprietary order flow information to provide a trader (or an automated trading system) with an enhanced version of a received market data feed that avoids the need for the trader or automated trading system to always wait for a response to a prior order from such exchange before submitting further orders. The data distribution system preferably comprises a geographically distributed data network with market data enhancement and intelligent order routing capabilities in each region that not only provides each region with market data that is enhanced with order flow data from other regions, but that also employs statistical data and heuristics to re-route and/or cancel orders from a trader in one region to an exchange in another region.

### CLAIM FOR PRIORITY

This application is a continuation in part of copending U.S. application entitled “Global Distributed Trading System” filed on 2 Sep. 2011 under Ser. No. 13/225,331. Application Ser. No. 13/225,331 is a continuation in part of copending U.S. application entitled “Global Distributed Trading System” filed on 14 Jan. 2011 under Ser. No. 13/007,562. Application Ser. No. 13/007,562 is a continuation in part of copending U.S. application entitled “Global Distributed Trading System” filed on 1 Mar. 2010 under Ser. No. 12/715,368. Application Ser. No. 12/715,368 is a continuation in part of copending U.S. application entitled “Global Distributed Trading System” filed on 5 Aug. 2009 under Ser. No. 12/536,460. Application Ser. No. 12/536,460 is a continuation in part of copending U.S. application entitled “Global Distributed Trading System” filed on 22 Jan. 2009 under Ser. No. 12/357,394, which is based on and claims priority from provisional United States application entitled “ARM Trading Architecture” filed on 22 Jan. 2008 under Ser. No. 61/022,701 and from provisional United States application entitled “In-Flight Modification of Orders in Response to New Market Data” filed on 24 Jul. 2008 under Ser. No. 61/083,276. Application Ser. No. 12/536,460 is also a continuation in part of copending U.S. application entitled “Method and Apparatus for Enhancing Market Data Feed Using Proprietary Order Flow” filed on 22 Jan. 2009 under Ser. No. 12/357,398, which also is based on and claims priority from provisional United States application entitled “ARM Trading Architecture” filed on 22 Jan. 2008 under Ser. No. 61/022,701. The teachings of all of the above identified applications are hereby incorporated by reference in their entirety.

### FIELD OF THE INVENTION

The present invention relates generally to a computer system, network architecture, and functionality for the communication of market data and orders between one or more financial instrument exchanges and a number of connected traders and/or automated trading systems that mitigates latency effects due to transmission delays between the traders and the exchanges, and more particularly to a geographically distributed data network that effectively permits the traders and trading systems to more effectively anticipate responses by an exchange to pending and future orders.

### BACKGROUND

### Exemplary Prior Art and Some of its Shortcomings

In a typical computerized electronic exchange (“ECN”), orders received from various traders (including ever increasing numbers of trading automata) to buy or sell a particular financial instrument are sorted by price and time to thereby create a book of open (i.e., available) buy and sell orders that are typically separated by a price spread.

Trading Client applications trade on the ECN via messages (network packets) that are relayed through a Gateway. As each order message is received by the exchange, its open order book is scanned and updated by a matching engine in an attempt to identify a compatible counterparty for the requested quantity (or possibly a lesser quantity) at the requested price (or possibly a better price), whereupon the concerned traders are notified of the details (time, price, quantity, counterparty, etc) of their deal and the dealt portion of the order is removed from the open order book. The exchange also regularly reports to its subscribers summary “ticker” information about those completed deals, typically just the highest and lowest prices paid since the last such “ticker” report. If no such match is found or if only part of the newly submitted order can be filled, any undealt portion of that order may be either be cancelled or added to the open order book, in accordance with the instructions of the submitting trader. In particular, an “IOC” (Immediate Or Cancel) order will be automatically cancelled by the exchange if it cannot be matched at the time it is received, and a “GTC” (Good 'Til Canceled) is kept open for possible matching with future orders until either a match is found or any remaining portion of the original order has been cancelled.

Each exchange customer maintains one or more private bi-directional communication channels for the customer's proprietary Order Flow (“OF”) events, which includes not only order submissions from the customer to the exchange as well as instructions to cancel previously submitted orders, but also acknowledgements from the exchange to the customer of those submissions and instructions as well as details of any resulting deals or cancellations.

Each exchange also provides one or more Market Data (“MD”) feeds to its subscribers in the form of the best buy (bid) and sell (offer) prices currently available for a specified quantity of each financial instrument, possibly supplemented with the previously mentioned ticker information and/or with additional information concerning open orders at other prices or for other quantities. It should be understood that each exchange has its own proprietary protocol and format for distributing MD, with some MD feed protocols providing only limited data (for example, only a best price from an acceptable counterparty) at infrequent intervals (for example, every 500 milliseconds), and other MD feed protocols providing essentially full details of any change in the open order book in essentially real time, omitting only the name of the trader submitting that order and the time at which it was received and when it will expire.

A customer may have a variety of incoming and outgoing data feeds, for example:

Thomson Reuters Matching (MD & OF)

Currenex (MD & OF)

Hotspot (MD & OF)

EBS Ai (MD & OF)

EBS Live (MD)

The order flow communication latency is usually significantly lower than the market data distribution latency (because it involves communication with only a single client and because that communication is of high priority and is not artificially throttled). A customer may also have a variety of servers each hosting one or more feeds. The same Feed can be provided by multiple servers. However, since there is no industry standard for transmitting and receiving either MD or OF data, there is no industry standard for consolidating or aggregating multiple sources of such data into a usable single data stream.

Markets are global and dispersed. Customers are located across the globe, an institution's trading desks are located in several cities, automated proprietary trading platforms may be trading from multiple centers, and in the particular case of foreign currency (FX) exchanges, the traders are typically dealing with at least four different exchanges in four cities on three continents. Trading messages travel across networks conceptually at the speed of light, yet even this is too slow in today's high frequency automated trading context. While it only takes a few microseconds or less for a message to travel between a co-located model and an exchange, it still takes approximately 20 milliseconds for a message to travel between New York and Chicago; this is a difference of three orders of magnitude. Between New York and London, the transmission time is about 30 milliseconds, between London and Tokyo it is about 120 milliseconds.

The term “timeslicing” describes the concept of sending updated market information on a timed basis, to thereby reduce transmission bandwidth. When each market update is sent, its contents reflect the state of the market at a particular time (or equivalently, any cumulative changes since the previous update). Another update is then scheduled to be sent a number of milliseconds later. Ideally, the delay reflects the (bandwidth-dependent) time that the communication lines are busy transmitting the original update—any new update sent during this time would have to be queued, resulting in obsolete market data. In fact, some exchanges have relatively long timeslicing intervals of 200-500 ms or longer. Information regarding sporadic potential opportunities—for example, favorable price changes—may be dropped from the market feed unless the new price is still in effect at the precise time another market update is being prepared. Any relevant market event (for example, an improved market price) is thus either dropped or is communicated with a delay ranging up to the full length of the timeslicing interval. To some extent, these limitations can be offset by restricting traders' ability to accept prices not yet visible at their trading floor and by submitting market feeds to different trading floors at different times and/or with different delays, but such expedients will be perceived as punitive by at least some of the more active exchange members, particularly those having several trading floors all located close to the exchange.

In the case of “synchronized timeslicing” (where market updates are sent to all subscribers at the same time), many orders from many different subscribers are submitted immediately in response to the update. The new market state is not communicated until the next update is sent. Market impact of these orders thus invalidates the content of the market update very shortly after the update is sent. Therefore, the average “latency” (elapsed time from the time of the market event to the time of the report) in a synchronized timeslicing report is nearly equal to the timeslicing interval (twice what would have been expected had the trading events been spread uniformly across the interval in question).

Another factor that affects bandwidth requirements and related queuing and distribution delays is the amount of market information that is distributed to market participants. If the market information is sufficiently detailed to define the entire open order book (a “transparent” market) a higher bandwidth is required, not only because the amount of information is greater, but because some of the market data elements require more frequent updates (for example, available best price volume changes more frequently than the best price itself).

Market data processing latency is greatest in markets such as foreign exchange where each client may have a different view of the market (exchange inventory available for trading) due to credit screening, which requires that the exchange computes a custom market view for each market participant.

Moreover, each trader (or automated trading model) must limit its risk exposure to possible market volatility and thus cannot have a large net commitment (real or potential) in any particular instrument and will not be able to submit more than a few open orders at any given time. Thus, after the trader has submitted an order to a particular exchange, he normally must wait until that order has been accepted or cancelled before he can submit a revised or better price to the same exchange or the same offer to another exchange. Accordingly, when a favorable market price is transmitted by a remote exchange to a particular trader or trading model, it is not always to the institution's advantage for the trader to submit an order in response, particularly if other traders from the same institution are located closer to that remote exchange. To some extent this can be alleviated by providing a sophisticated order routing system that screens all outgoing orders from a particular trading floor, or even the entire institution, for possible conflicts and duplicates, and automatically cancels or re-routes some or all of the crossed or duplicate orders before they are transmitted to the exchange.

Particularly in the case of automated trading models that analyze the incoming market data in essentially real time for potentially profitable arbitrage trades involving multiple exchanges and/or multiple financial instruments, the trader or automated trading model having the most complete and up to date market data has a clear advantage. Not only will it be able to make profitable deals ahead of his competition, it will not waste valuable time submitting orders at prices that are no longer available or attempting to cancel orders that probably should not have been submitted in the first place. In particular, when market data is delayed by distance or bandwidth or the contents of market data is artificially limited by the exchange, the utilization and profitability of automated trading models is reduced.

A further problem arises when a trader, which may be a person or an automated trading model, submits an order to a remote exchange. This is particularly acute when a trader or trading model is on one continent and one or more exchanges are on another continent. For example, traders or trading models in London may need to deal on Hotspot and Currenex, which are both based in New York, as well as exchanges in London. A trader may submit an order to an exchange at a distant location which, based on information available at the trader's location, appears to the trader to have a matching order available. By the time the order reaches the distant location, the matching order at the destination exchange is no longer available and the trader's order is rejected—yet a matching order was contemporaneously available on another adjacent exchange. The trader must wait for notification that his order has been rejected by the destination exchange before submitting the order back to the adjacent exchange where that order may by that time not be available.

Additionally, a trader may become aware of a better price on an exchange other than the one to which he submitted the order yet he is unable to modify the order which is by then ‘in flight’ to the exchange. More specifically (and as illustrated in FIG. 1) an automated trading client (for example, a trading strategy) S of a distant trading venue X (for example, a financial exchange or a bank portal) monitors market data stream provided by the venue. When a trading opportunity arises (for example, the offer price drops), the trading client submits an order to trade (for example a buy order). Because of the distance and network delays, the order may take considerable time delta to be received and processed by the exchange—tens or hundreds of milliseconds. During this time the trading client may receive additional new market data from the venue X, indicating that the original trading opportunity has disappeared. The trading client may also see that the opportunity has now appeared on other venue(s) Y, but is not able to cancel the original order. The order is “in flight” as an electronic message and if the opportunity reappears on the distant venue, it will be executed. Thus, if the trading client submits another buy to another venue, it risks a double fill of the order.

A further missed opportunity for traders is that the best component legs of a compound order may be available only on different continents. More specifically, some instruments in financial markets may be synthesized from two or more other instruments. For example, in foreign exchange, an order to buy one million EUR/CHF is in all respects equivalent to an order to buy one million EUR/USD and then to buy USD/CHF, each of these component transactions being termed ‘legs’. However, if the exchange on which the best price is available for EUR/USD is separate from the exchange on which the best price USD/CHF is available, a trader is at considerable risk that he may secure one leg but not the other due to the latency of market data from a distant exchange and the length of time for his order to reach that distant exchange. In traders' terminology, he is at high risk of being “one leg up”.

### SUMMARY DISCLOSURE OF PROPOSED SOLUTION(S)

The external market data typically received from an exchange by its customers are combined in a proprietary data distribution network with proprietary order flow data not known to other unrelated exchange customers (such as pending orders from the receiving institution that are not yet reflected in the market data currently being transmitted by the exchange to all of its subscribers) to produce enhanced market data that will more accurately reflect the prices and quantities that will actually be available to traders and trading platforms at the receiving location resulting from newly submitted orders at either a better price (which may be reflected in a new best price) or at the current best price (which will be reflected in a changed or null available quantity at that price), or even at an inferior price (which may result in increased liquidity). That enhanced market data may then be distributed to one or more trading clients or other trading systems within the same premises, institution or organization, possibly further enhanced by more recent order flow from the receiving clients and systems, combined with similarly enhanced market data from other exchanges and/or converted into a different format with more or less frequent updates than the original market data feed(s).

Each local matching engine has access to both the market data and the order flow information. To consider a typical example, let's suppose that the exchange transmission latency is non-trivial (e.g., 50 ms one-way London-NY latency), and that the most recent market data indicated the best offer price of 1.2345 with 5 units being available at that price. If one of the Trading Clients submits an order to buy 3 units at that price, the data distribution network forwards that order to the exchange. Once the 3-unit buy order is dispatched to the ECN, no more than 2 units of the specific 5-unit quantity advertised by the ECN are available to any of the Trading Clients (because the market offer or offers that make up the best offer price will be either consumed by the match with the buy offer in question, or otherwise consumed or cancelled before the ECN receives the buy order in question). Therefore, the data distribution network immediately notifies all of the Trading Client components that the current exchange best offer inventory is only 2 units. Note that this “predictive market data” is generated 50 ms before the ECN will receive the buy order and at least 100 ms before the ECN's market data reflecting that future effect of the buy order on the ECN's order book are received by the Gateway. This predictive market data is typically generated and delivered to the Trading Clients within tens or hundreds of microseconds.

Whenever there is a material change in either the MIO data or the raw VOB data, the VOB processor preferably combines the current MIO data with the current raw VOB to thereby regenerate the enhanced VOB (or equivalently, calculates the changes to the enhanced VOB resulting from the changes to the MIO and raw VOB data), preferably using the same matching criteria and cancellation policy as the exchange to delete not only any previously entered orders that have now been cancelled but also any previously entered buy or sell orders that would have resulted in completed deals once the recently submitted buy (or sell) orders in the customer order flow have been matched with any compatible sell (or buy) orders already present in the raw VOB.

For each instrument traded on a particular ECN, a corresponding local matching engine in the data distribution network maintains a data structure called a Virtual Order Book (VOB) that represents the ECN's order book and that is initialized based on ECN's market data. The VOB is updated for every new order event (order submission, cancellation, etc.) based on ECN's published matching algorithm. However, maintaining the VOB (predictive market data) in response to further market data updates from the ECN is relatively complex task, as will be apparent from the detailed description that follows.

Preferably, the various data are time stamped with the approximate time (or time interval) they would have been received at or transmitted from the involved exchange, and the recent customer order flow is input to a Market Impact Overlay (“MIO”) processor which generates a time-ordered MIO data sequence which contains the order flow data for those customer orders (or instructions to cancel previously submitted orders) which have been recently submitted to the exchange, but for which (because of predictable technical reasons such as time slicing and transmission delays) sufficient time has not elapsed for them to be reflected in the current market data already received from the exchange. Concurrently, the received current market data is preferably input to a Virtual Order Book (“VOB”) processor which not only converts the received market data into a raw VOB of respective “implied” orders that correspond to each of the currently available prices and quantities detailed in the most recently received market data, but which preferably also includes an Obscure Order Processor (“OOP”) which takes into account an estimate of “obscure” orders that would probably also be present at that same time in the order book maintained by the exchange, but are too far removed from the current market price to be included in the current market data. The raw VOB may then be combined with the MIO data to produce an enhanced VOB, as is described in more detail hereinafter.

In one preferred embodiment, the orders and other information (such as exchange generated cancellations and executed deals) contained in the recent customer order flow are preferably analyzed to identify any included details of “authentic” customer orders that have already been received by the remote exchange but no matching deal was found so they would have been placed in the exchange's open order book and a sufficient time has elapsed that they are presumably now reflected in the received market data and thus are already included in the raw VOB, in which case not only is that “authentic” order removed from the MIO data, the corresponding data in the raw VOB is henceforth identified and maintained as an “authentic” portion of any similarly priced implied order, and is removed from the raw VOB only after subsequent OF or MD data establishes that it would have been dealt or cancelled by the exchange.

In accordance with another aspect of a presently preferred embodiment, the enhanced market data may optionally be distributed as market views of the enhanced VOB, which may be in the same format as a particular source exchange or in any other desired format.

In a particularly advantageous geographically distributed embodiment, a MIO processor at a particular location closer to the exchange may have access to customer OF data from one or more remote locations, and the resultant enhanced market data (preferably in the form of an enhanced VOB) is shared not only with traders at the closer location but also is broadcast to those more remote locations, whose respective VOB processors may further enhance the shared enhanced MD with more recent OF data that would have not been received by the closer location at the time the enhanced MD was broadcast.

In such a distributed ARM architecture, the requesting amount requested, price limit, and/or other filtering criteria may aggregated for an entire region rather than for each specific order. When submitting orders to exchanges in the preferred embodiment, routing nodes are situated close to each cluster of exchanges. These routing nodes regard all components including all connected exchanges and other routing nodes as order sources. The routing nodes may have additional capabilities including aggregation and internal matching and are known as Aggregation, Routing and Matching engines (ARM engines'). The routing logic may be simplified by treating all connected components simply as order sources irrespective of whether they are, for example, exchanges or other ARM engines. Orders are not just routed from the original order source but may be re-routed in whole or in part on arrival at a distant ARM engine according to the latest available information.

One preferred embodiment incorporates means to modify an order in-flight between ARM engines. In an alternative embodiment, the method of amending orders in-flight may be implemented by an exchange.

Another embodiment permits implementation of compound orders having one leg on an exchange or ARM engine in one location and another leg in an exchange or ARM engine in a distant location.

### FIGURES

FIG. 1 illustrates a prior art solution for a trader viewing data from both a distant venue and a local venue, and then submitting an order to the distant venue and receiving an acknowledgement of his order from the distant venue.

FIG. 2 is a functional block diagram of a basic exemplary MD enhancer which is responsible for market data from a single feed concerning a single financial instrument being traded on a single exchange and which has a local matching engine for combining that market data with the customer's proprietary order flow to form an enhanced VOB.

FIG. 3 is a block diagram of an exemplary MD enhancer system based on the MD enhancer of FIG. 2, but expanded to incorporate other feeds from the same and other exchanges, to thereby create multiple market views and deal views based on various combinations of feeds and exchanges.

FIG. 4 shows an exemplary installation of the system of FIG. 3 connected via customer premise equipment to multiple exchanges.

FIG. 5 shows an alternative configuration for connecting multiple customer sites to the same exchange, whereby a customer site closer to a particular exchange is responsible for routing all orders to that exchange and a second MD enhancer system at a more remote customer site receives enhanced market data from a first MD enhancer system at the closer site, which may then further enhance that enhanced data.

FIG. 6 Shows a possible implementation of the ARM topology, as it could be deployed in four regions (Chicago, London, New York and Tokyo) with direct data transmission possible between each pair of regions.

FIG. 7 shows a generalized ARM topology forming a clique tree.

FIG. 8 shows an ARM configuration optimized for geography, in which all communications with Tokyo are routed through New York.

FIG. 9 shows various components (processing modules) of an exemplary ARM architecture and the logical connections between the components.

FIG. 10 (comprising FIG. 10A and FIG. 10B) shows a modified version of the system of FIG. 5, in which communication between regions is conducted over a single bidirectional communications channel for synchronous transmission of both enhanced market data from the remote exchange (preferably in the form of a VOB) and order flow data to that exchange.

FIG. 11 shows basic functionality that allows in-flight cancellation of orders as implemented in an exchange.

FIG. 12 shows the same functionality as FIG. 10 but implemented in the ARM architecture.

### DETAILED DISCLOSURE OF PREFERRED EMBODIMENTS

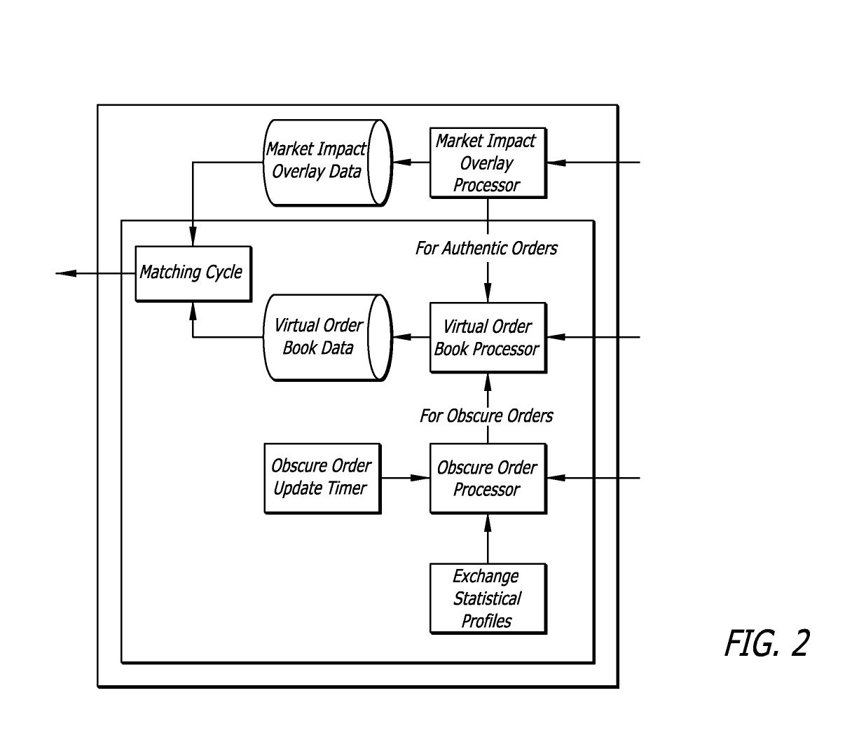

FIG. 2 is a functional block diagram of a basic MD enhancer module which includes the MIO processor and VOB processor functionality responsible for market data flow from a single feed (for example, Reuters “Market Data”) for a single type of financial instrument (for example, Spot USD/JPY) being traded on a single exchange (for example, Thomson Reuters London).

In particular, all Order Flow (OF) for the involved institution (trader, trading floor, company or organization of associated companies) dealing on a particular exchange in a particular financial instrument is processed by a MIO processor which preferably maintains a time ordered list of recently submitted orders and cancels (MIO Data) each time stamped with its presumed (future) time of receipt at the exchange, and discards (or ignores) each such recently submitted order or cancel only after it is now reflected in the market data received from the exchange. The cutoff time for such a discard is based on exchange specific heuristics and observations concerning processing and transmissions latencies, frequency and timing of market reports, etc, which establishes a time window or time delta relative to the time stamped presumed time of receipt at the exchange during which there is a high probability (for example a confidence level of 95%) that a particular order or cancel has not only been received and processed by the exchange, but that any resultant change in the exchange order book has already been reflected in any similarly time stamped market data currently being received from the exchange. These time deltas are preferably updated periodically and a similar process is preferably used to establish the presumed (past) exchange time for MD and OF events that originated from the exchange but were not tagged with the relevant time by the exchange.

The VOB processor preferably maintains a current VOB data structure that represents an attempt to reconstruct at least the visible portion of the exchange's order book at the time the MD was last updated, by creating a number of “implied” orders from the current MD, each such implied order corresponding to an indicated total quantity available at an indicated price.

Since the incoming market data from the exchange will typically not indicate any prices and quantities more than a level or two behind the best price, and thus do not give a full picture of the market depth (liquidity), the VOB processor preferably also includes a separate process for creating “obscure” orders for other prices behind the indicated prices which include an estimate of the available quantity at each of those other price levels, which may be based on a combination of historical data derived liquidity curves and hints of additional liquidity based on different prices for “regular” and “best”, and on previously visible implied orders that have in the meantime become bettered, preferably using a decay factor to reflect expected cancellations.

The reconstructed raw VOB preferably also takes into account the current status of the customer's own previously submitted “authentic” orders to the extent sufficient time has elapsed since their submission for them to be now reflected in the received MD. In particular, once that time has elapsed and the authentic orders have been removed from the MIO data, a corresponding order for the same quantity is placed into the raw VOB, and that same quantity is subtracted from any similarly priced implied orders but will have no effect on any similarly priced obscure orders.

Each time updated MD is received from the exchange, the VOB is regenerated not only with newly calculated implied orders, but also with newly calculated obscure orders. The authentic orders remain in the VOB until either cancelled or until matched with a subsequent order.

The combining of the MIO data with the VOB data is preferably performed by a matching engine which emulates the deal matching process at the exchange, for example, by taking the MIO data one at a time and attempting to match it in against each successive entry in the VOB until a compatible match has been found, in which case the matched portion of the order is removed from both the VOB (to thereby create an Updated VOB) and from the MIO, an attempt is made to match any remaining unmatched portion in the MIO with subsequent entries in the VOB, and then the process is repeated for the next entry in the MIO. In the event that the matching process identifies not only a compatible authentic order but also a quantity of an implied or obscure order, precedence is given to the authentic order, however it may be restored in the event that the subsequent OF data confirms that it is still pending.

The advantage of performing such a redundant matching process locally rather than simply waiting for the official deal notification message to be received from the exchange, is that the customer obtains advance knowledge of a potentially market altering event: the customer's emulated matching engine has knowledge of the trader's own orders (and importantly, all the trading orders from any other more remotely located trading floor or automated trading platform from the same institution) even before those order has been received by the exchange.

The result is a stream of continually updated enhanced MD, which not only reflects transactions that have been processed by the exchange but for technical reasons such as reporting frequency and transmission latency are not immediately included in the received MD, but even reflects changes in available price and quantity resulting from orders that have not yet arrived at the exchange. Since the MIO and VOB data being matched at the customer site were not necessarily created in the same sequence as the actual orders would have arrived at the exchange, the entire matching process is preferably repeated each time there is a change to previously matched VOB data, or to previously matched data in the MIO.

For most modern ECN's, the VOB can be adequately represented as a list of bid and offer prices together with the amount that is available in the ECN inventory at that price:

| Bid Price | Bid Amount |
|---|---|
| 1.2344 | 1M |
| 1.2343 | 4M |
| . . . | . . . |

| Offer Price | Offer Amount |
|---|---|
| 1.2345 | 3M |
| 1.2346 | 7M |
| . . . | . . . |

The MIO (Market Impact Overlay) may be thought of as a queue of events ordered by event's ECN time. For each order flow event not yet reflected in the last piece of market data received from the ECN (because of latency), we record the resulting state of the VOB computed by the Market Processor component:

| ECN Time | MIO Event | Resulting VOB state |
|---|---|---|
| | (Last market data received from ECN) | . . . |
| T1 | Buy 45/2M | . . . |
| T2 | Cancel Buy 45/2M | . . . |
| . . . | . . . | . . . |

The following describes the processing steps performed by the Market Processor component in response to certain events.

### New Order Flow Event

1. Add the new order flow event to the MIO queue. Compute the resulting VOB state after this event (and any subsequent events).
2. Publish the VOB state associated with the last entry in the MIO as the new enhanced market data (if the state differs from the last published state).
   New Market Data is Received from the Exchange
1. Determine which of the MIO entries are reflected in the market data and remove them from the MIO queue.
   a. Remove all MIO entries whose age is above predetermined threshold depending on known ECN maximum latency.
   b. Of the remaining MIO entries, preserve all entries whose age is below predetermined threshold depending on known ECN minimum latency.
   c. Of the remaining MIO entries, find the earliest entry whose associated resulting VOB state is the least dissimilar (least “dissonant,” see below) from the VOB state reflected in the received market data message. Remove all oldest MIO entries up to and including this entry from the MIO queue.
2. Starting with the VOB state reflected in the received market data message, re-compute the effect of each order flow event in the MIO queue and record this as the associated resulting VOB state for the event.
3. Publish the VOB state associated with the last entry in the MIO as the new enhanced market data (if the state differs from the last published state).

### Dissonance Measurement

The dissimilarity measurement used in the step 1.c. above is called “dissonance.” It may be approximated by simply summing the absolute differences between the order book inventory amounts available at each price level. Other dissimilarity measurements that could be used in this step include square root of the sum of squares of differences, or similar multi-dimensional metrics. We consider a typical example, where the market data sent by the ECN indicates the total amount of passive orders (bids and offers) available at each price level. For simplicity, the example shall consider only the offer inventory of the ECN.

Initial market data received from the ECN indicates the following inventory:

| Offer Price | Offer Amount |
|---|---|
| 1.2345 | 3M |
| 1.2346 | 7M |
| 1.2347 | 4M |

For brevity, we record this as follows: (45/3M, 46/7M, 47/4M). This represents the state of the VOB after the initial market data message was received.

One of the Trading Clients submits an IOC Buy order for 1M at the price of 1.2345. The state of the VOB after the order was dispatched to the ECN is computed as (45/2M, 46/7M, 47/4M). At this point, the MIO consists of a single event. The resulting VOB state is recorded alongside the event in the MIO:

| Time | MIO Event | Resulting VOB state |
|---|---|---|
| | (market data) | 45/3M, 46/7M, 47/4M |
| T1 | Buy 45/1M | 45/2M, 46/7M, 47/4M |

The enhanced marked data (45/2M, 46/7M, 47/4M) is published at time T1.

Suppose that, shortly afterwards, two other Trading Clients submit each a Buy order 45/3M. The MIO looks now as follows:

| Time | MIO Event | Resulting VOB state |
|---|---|---|
| | (market data) | 45/3M, 46/7M, 47/4M |
| T1 | Buy 45/1M | 45/2M, 46/7M, 47/4M |
| T2 | Buy 45/3M | 46/7M, 47/4M |
| T3 | Buy 45/3M | 46/7M, 47/4M |

Enhanced marked data (46/7M, 47/4M) is published at T2. No additional enhanced market data is published at T3 because the resulting VOB state does not change.

Suppose that, shortly afterwards, new market data (45/1M, 46/7M, 47/4M) is received from the ECN. Assuming that none of the MIO entries are removed because of time constraints (in steps 1.a and 1.b), the first two MIO entries (T1 and T2) will have the least dissonance (the dissonance of both entries with respect to the new market data is 1M) and, thus, the earlier one (T1) will be removed from the MIO queue. The resulting MIO will be:

| Time | MIO Event | Resulting VOB state |
|---|---|---|
| | (market data) | 45/1M, 46/7M, 47/4M |
| T2 | Buy 45/3M | 46/7M, 47/4M |
| T3 | Buy 45/3M | 46/7M, 47/4M |

No additional enhanced market data is published at this time, because the resulting VOB state of the last MIO entry did not change.

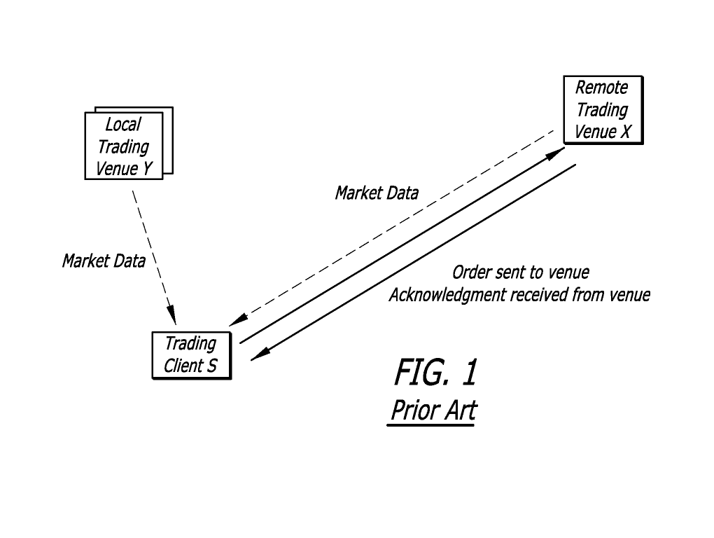

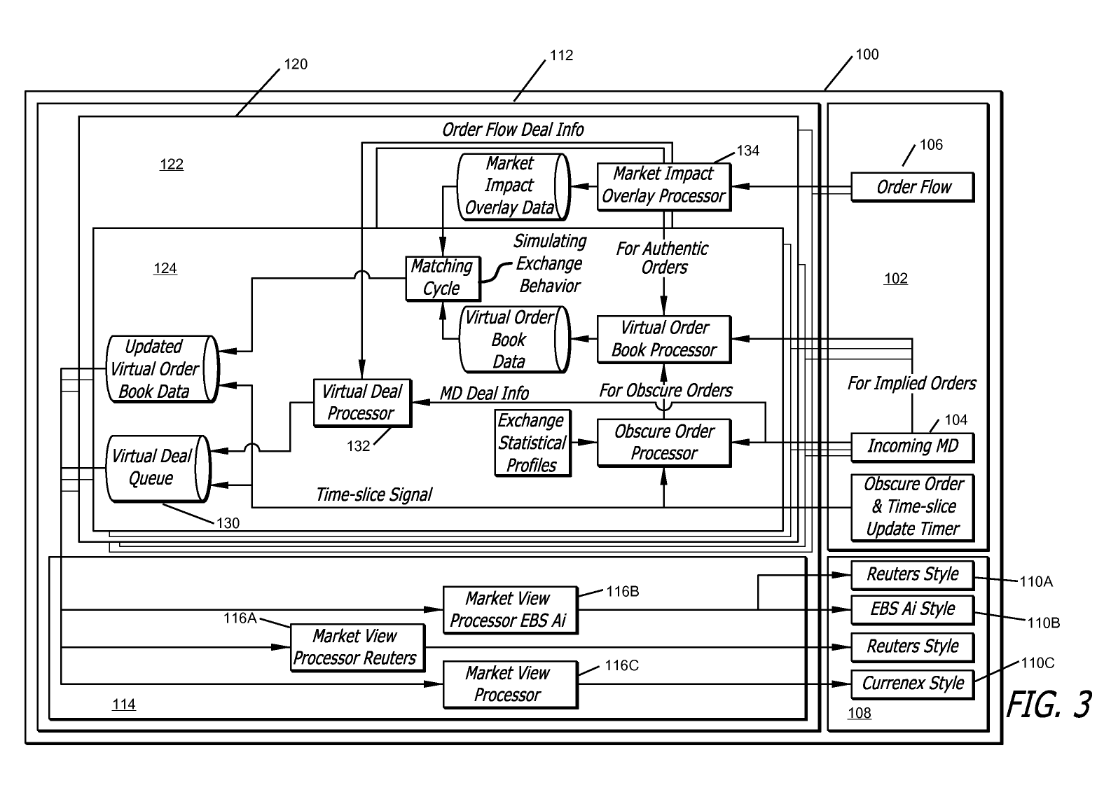

Reference should now be made to FIG. 3, in which the basic MD enhancer system of FIG. 1 has been expanded in modular fashion to include an entire “atomic market” of interest (for example, a particular financial instrument such as SPOT USD/JPY), to thereby incorporate other feeds from the same and other exchanges, from which multiple market views and deal views may be generated by respective Market View Processors (“MVP”) based on various combinations of those feeds and exchanges. Although not explicitly shown in FIG. 3, such a modular system may be further expanded to include other atomic markets served by the same exchanges and market feeds.

Depending on trading volumes and data processing rates, more than one modular logical process can be implemented on the same physical processor and conversely a single logical process can be divided hierarchically into several processes each implemented on a different physical process. In the illustrated embodiment, the overall market view enhancement processor 100 has three major components, an input interface 102 including an incoming exchange interface 104 and an incoming order interface 106, an output interface 108 including a plurality of customer specific data formatting components 110A,110B,110C, and a market data enhancing component 112.

MD enhancer 112 preferably includes a data distribution component 114 including a plurality of market view processors 116A,116B,116C which each are capable of composing and outputting a respective stream of market view information from the enhanced VOB (possibly consolidated or aggregated from other enhanced VOB's) using any defined methodology (timing, summaries, filtering, format, etc), and including market events from any defined source (the entire order book, or from one or more specified exchanges in one or more specified regions). In particular, it is possible to provide a trading model originally designed for operation with one exchange with market data originating from another exchange or from multiple exchanges, and then use customized router logic in a separate order router to determine how to route any resultant orders to the proper exchange. Data distributor 114 is preferably also capable of outputting the entire enhanced VOB in the native format used internally by MD enhancer 112, for subsequent possible analysis or enhancement by other processors that were designed for use with that same native format.

In the illustrated preferred embodiment, the heart of MD enhancer 112 is a hierarchy of a logically separate market level processing module 120 for each atomic market (for example, a particular financial instrument such as SPOT USD/JPY). Market level module 120 in turn includes several exchange level MIO processing modules 122 which each include one or more feed level VOB processing modules 124. Although not explicitly shown, the enhanced VOB output from several such market level modules 120 may be readily converted into a single aggregated enhanced VOB, since each exchange operates independently from the others and there is no need to maintain exact time synchronization between market events occurring on different exchanges.

For the most part, the individual components of MD enhancer 112 are the functional equivalents of the similarly named components of the basic MD enhancer of FIG. 2, and the previous description of the FIG. 2 embodiment is equally applicable to the FIG. 3 embodiment, with the exception of the Virtual Deal Queue (VDQ) 130 in the data feed level 124.

VDQ 130 is maintained by a connected virtual deal processor 132 which in turn is responsive to the same incoming MD as the was input at the data feed level 124 to the VOB processor, supplemented by the same OF as was input at the exchange level 122 to the MIO 134. As mentioned previously, the MD feed will typically include a summary ticker report on the highest and lowest prices dealt during the reported time slice, and the OF feed will include proprietary information about all deals made by the subscriber on the same exchange, including information about deals that were made after the last MD ticker report was generated. Accordingly, the VDQ processor 132 merely examines the recent OF for recent deal prices outside the last reported ticker and if so appends that price to the VDQ, which is then available for distribution to individual traders and trading platforms in accordance with their standing instructions to data distributor 114.

“Consolidation” is a mechanism that gives the customer the ability to combine MD concerning the same exchange, but reflecting different market events. For example, if a particular customer subscribes to two different MD feeds from the same exchange that reflect the same atomic market at different times with different levels of detail, the resultant separate enhanced VOB's are preferably consolidated into a single output stream of enhanced MD, and if that single stream contains time-related market data from different feeds that describes the same market at the same time, that time-related data is considered a single event and preferably is batched into a single message.

Similarly, enhanced MD originating from two different exchanges trading in the same financial instrument (the same atomic market) are preferably “aggregated” to provide an overview of the entire market, not just what is happening at a particular exchange. Each open order (whether authentic, implied, or obscure) in the resultant aggregated enhanced VOB is preferably tagged not only with the relevant time, but also with its source, thereby giving the trader the ability to make a more intelligent exchange selection when the same price is available from multiple sources. Conversely, the trader can simply request a price and quantity, and leave the order routing details to others. This is especially useful if the trader is part of an institution that employs a network of sophisticated order routers at multiple locations which each have the ability to make independent routing decisions as to which order should be directed to which exchange based upon the proximity and market liquidity of those exchanges still offering the requested quantity at the requested price.

“Batching” is a mechanism that gives a customer the ability to subscribe to enhanced market data for groups of feeds and/or markets and within the context of the subscription, maintain the original “atomic” nature of the incoming order flow or market data events, after they have been processed across multiple parallel components. preferably, the exchange MD interface assigns a unique ID to each such batch (typically a single message containing market event data relevant to more than one feed and/or market) of incoming MD and/or OF data. After each such batch has been split up and the respective data for each separate atomic market (e.g., a different currency pair) has been routed to a different VOB enhancer engine, the resulting multiple outputs of enhanced VOB data associated from that same batch of incoming data can then be consolidated by the enhanced MD interface into the same batch of outgoing data, in a style and format preferred by the receiving trading model.

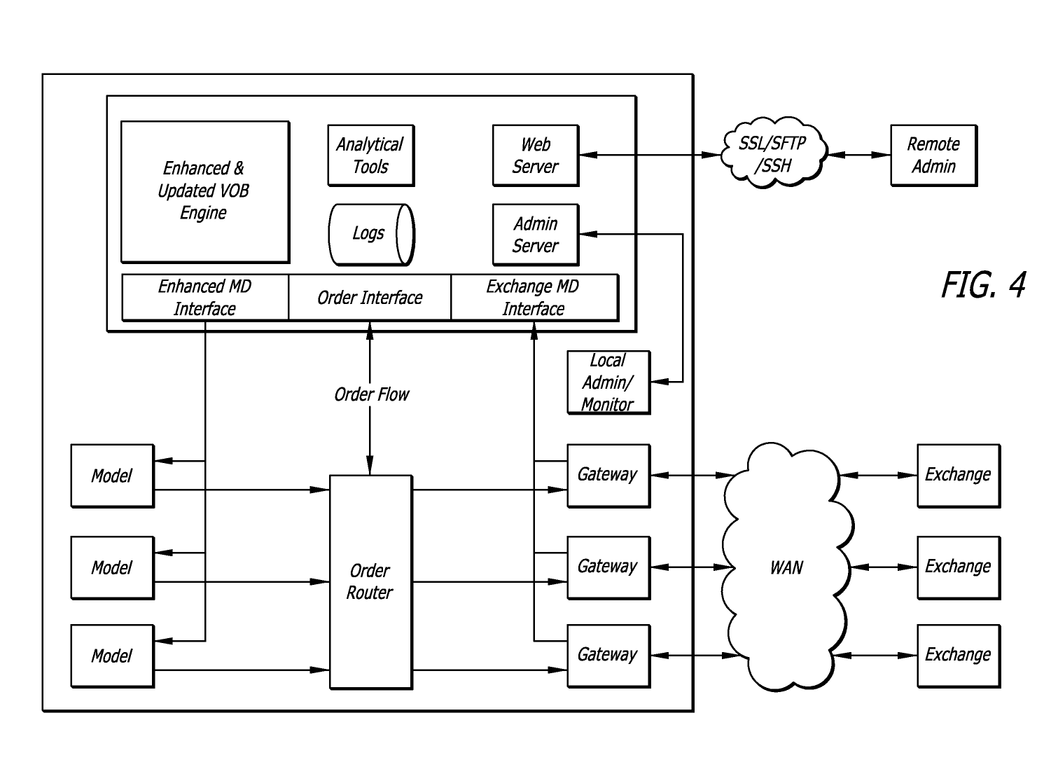

FIG. 4 shows an exemplary installation of the MD enhancer system of FIG. 3 connected via customer premise equipment to multiple exchanges via respective gateways, which are each not only responsible for the proper transmission of the customer OF feed from a customer-specific order router to the designated exchange via a Wide Area Network (WAN), but also responsible for the proper transmission in the reverse direction of the MD and OF feeds from the exchange to the MD enhancer system via an exchange MD interface. As shown, the order router simply routes orders from the various traders and trading models to the gateway associated with the particular exchange selected by the trader, and simultaneously informs the MD enhancer system with details of those orders. The system also includes an enhanced MD interface which routes customized versions of the enhanced MD to the respective trading models.

As illustrated, the installed MD enhancer system is also preferably provided with analytical tools and logs, and can be administered either locally or over a secure connection to a remote administrator. In one preferred embodiment, the distributed market views available to a particular trader or trading platform may include an analytical MD feed that alternates at regular intervals (for example, every minute) between the original received market data and the enhanced market data, which provides the administrator with a useful analytical tool for quantifying any changes in an automated trading platform's performance attributable to the differences between the original and enhanced data.

Moreover, as discussed in more detail below, the order router could be one modular component of a more complex and intelligent order routing system responsible for optimal routing and rerouting of orders to different exchanges based on expected transmission delays and current market conditions. In order to more accurately determine the exact point in the time ordered MIO Data queue which corresponds to the true exchange time the current market data was generated and thus separates the order data already reflected in the current market data from the more recent order data that has not already been incorporated in the current market data, longer and shorter test sequences of current MIO data with different cutoff times may be successively combined with a previously received market data timeslice and the result compared to the most recently received market data timeslice, the test sequence producing the best match will indicate which of the orders and cancels currently included in the MIO data are now reflected in the current MD time slice, and thus should now be ignored (or discarded).

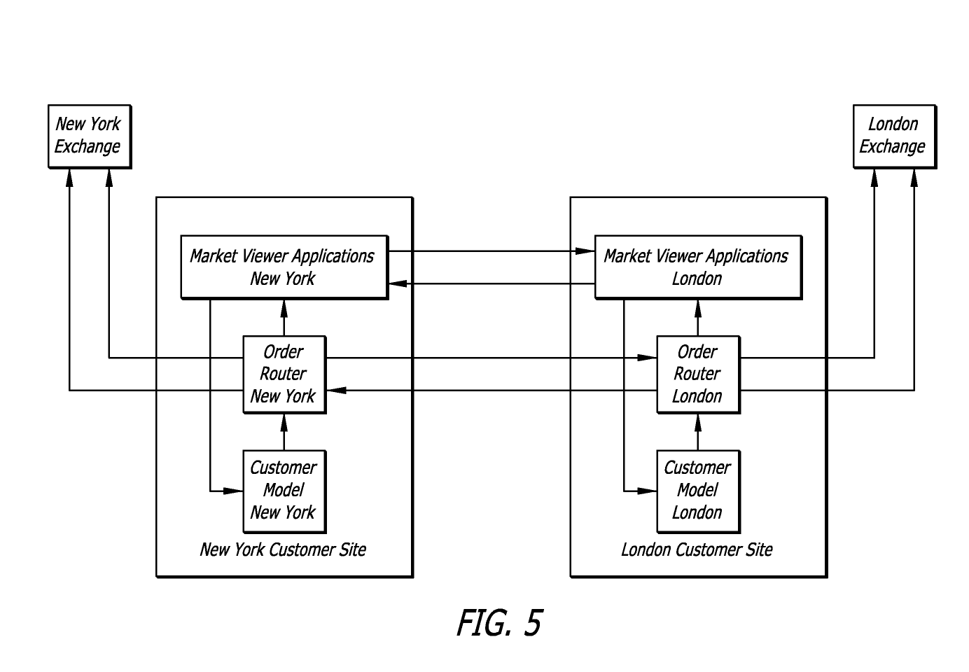

FIG. 5 shows an alternative configuration for connecting multiple customer sites to the same exchange, whereby a customer site (e.g., NY) closer to a particular exchange is responsible for routing all orders to that exchange and a second MD enhancer system at a more remote customer site (e.g. London) receives enhanced market data from a first MD enhancer system at the closer site, which may then further enhance that enhanced data.

Since the VOB processor at the closer location has already determined the best match between the exchange time associated with the current MD and the exchange times reflected in the recent OF, the remote VOB processors will preferably use that same timing to further enhance the received enhanced MD with similarly time stamped OF known to the remote VOB processor but not yet known to the closer VOB processor, preferably emulating the same VOB updating processes as used by the VOB processor at the closer location, so that synchronism is maintained between the updated VOB at the remote location and the correspondingly time stamped entries in the subsequently updated VOB at the closer location.

In the illustrated example, not only is the London site relieved of responsibility for determining the true NY exchange time each time a new batch of MD is received from the NY exchange, the received NY enhanced MD presumably had been updated in NY whenever any relevant acknowledgement of a London order or other London market events had been received from the NY exchange, so that the London site does not have to be concerned with identifying any authentic orders or estimating any obscure or implied orders or otherwise revising the current VOB, but merely has to perform a supplemental matching cycle on the current VOB using any unacknowledged London orders or cancels in the current London MIO that are not already reflected in the received NY enhanced VOB.

### Autonomous Orders

Each routing nodes may include additional capabilities such as aggregation and internal matching of orders and preferably regards all other network components including all connected exchanges and other routing nodes as order sources.

By so treating all connected components simply as order sources (that have different capabilities), the routing logic may be greatly simplified. Even a data distributor component is such an order source. In fact, there is no need to make a clear distinction between ARM Engines and order sources—both may be considered “ARM Components.”

Once the “highways” (the basic routing rules) are thus simplified, the logical routing capabilities can be safely made more complex without the application becoming unmanageable (e.g., orders can be routed to the destination through an arbitrary path, matching limits can be specified, etc., etc.).

### Topology

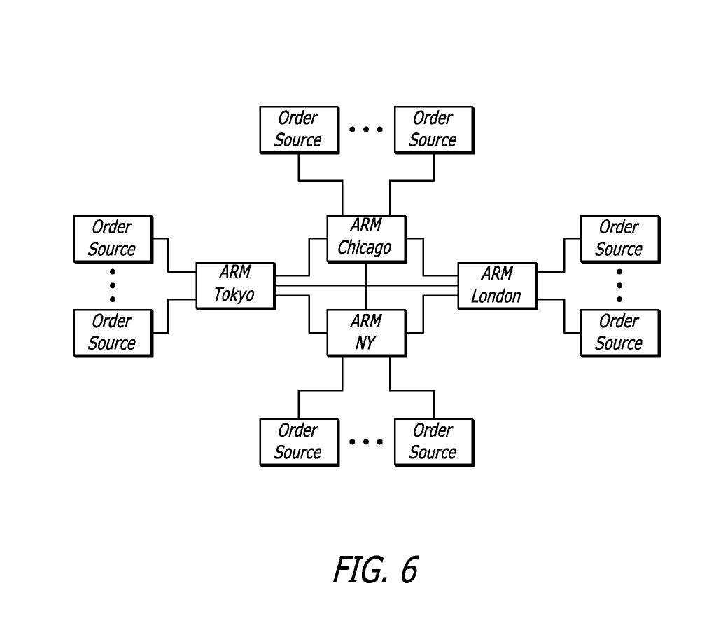

The ARM architecture is preferably in the form of a “clique” of ARM Engines, with each External Exchange and each Order Processor being connected to one of the ARM Engines (FIG. 6).

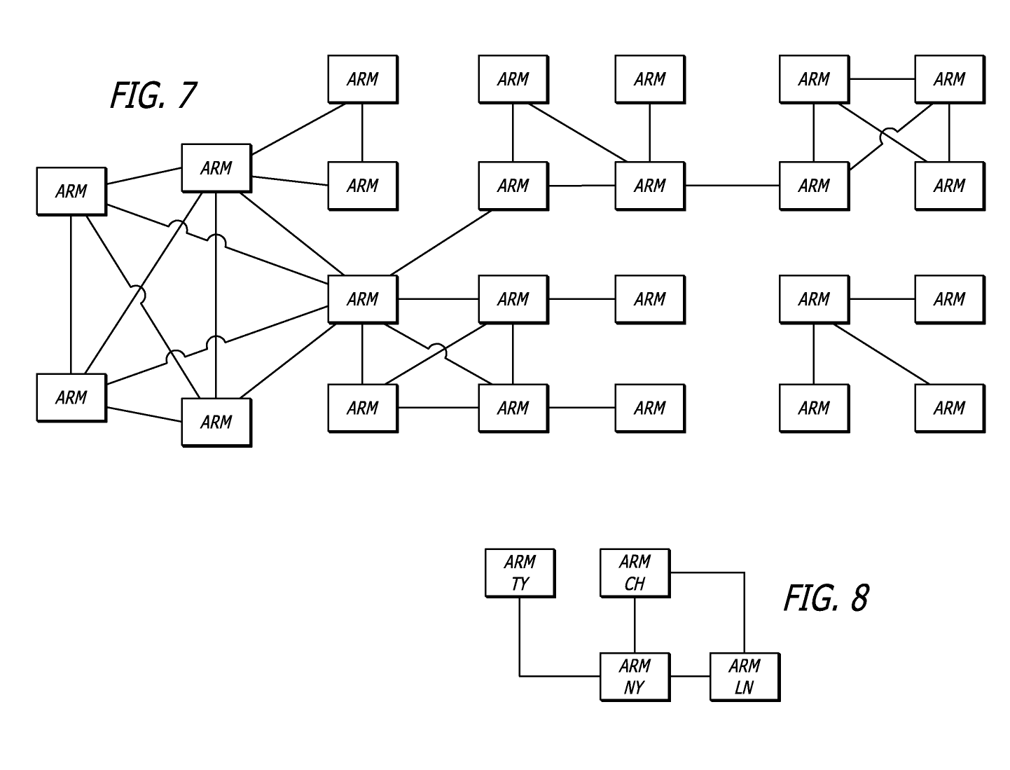

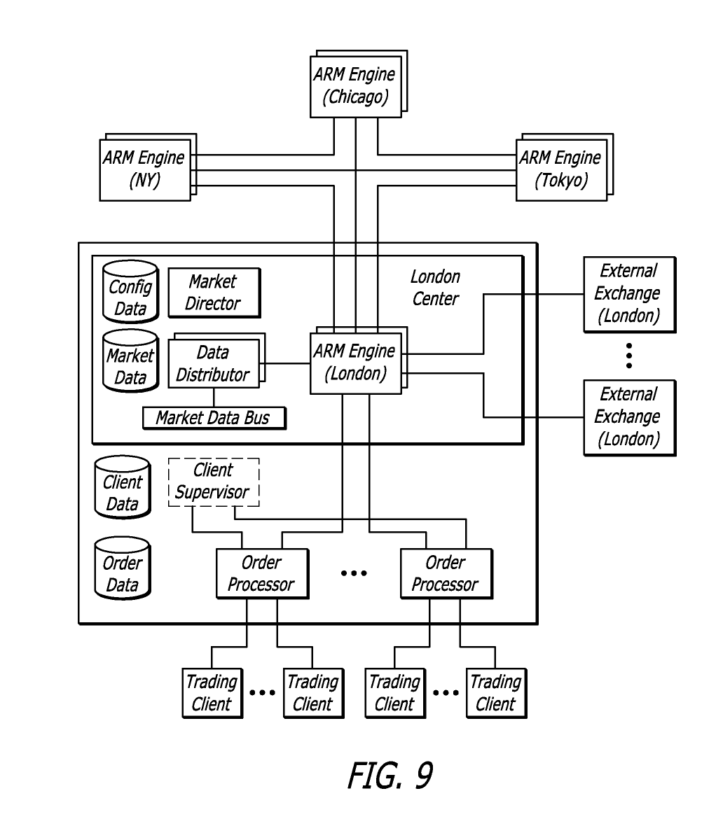

It should be noted that ARM architecture is extensible to topologies other than the “matching clique,” the most general form being called a clique tree. (A clique tree is a graph in which every cycle induces a clique, see FIG. 7.) One efficient way to connect the ARM Engines would follow the underlying telco connectivity—recognizing the fact that most London-Tokyo circuits are routed through US (FIG. 8). This configuration increases matching opportunities while having only a slight impact on network latency.

Thus, the basic ARM topology can be configured in very flexible ways to address diverse geographic deployment requirements irrespective of the location of the exchange, preferably combining the routing node, the aggregator node, and the internal exchange into one component called the ARM Engine. This:

1. Simplifies and speeds up internalization logic;
2. Reduces latency (by eliminating intercomponent connections and number of “hops”); and
3. Minimizes the number of logical connections.

### ARM Architectural Framework

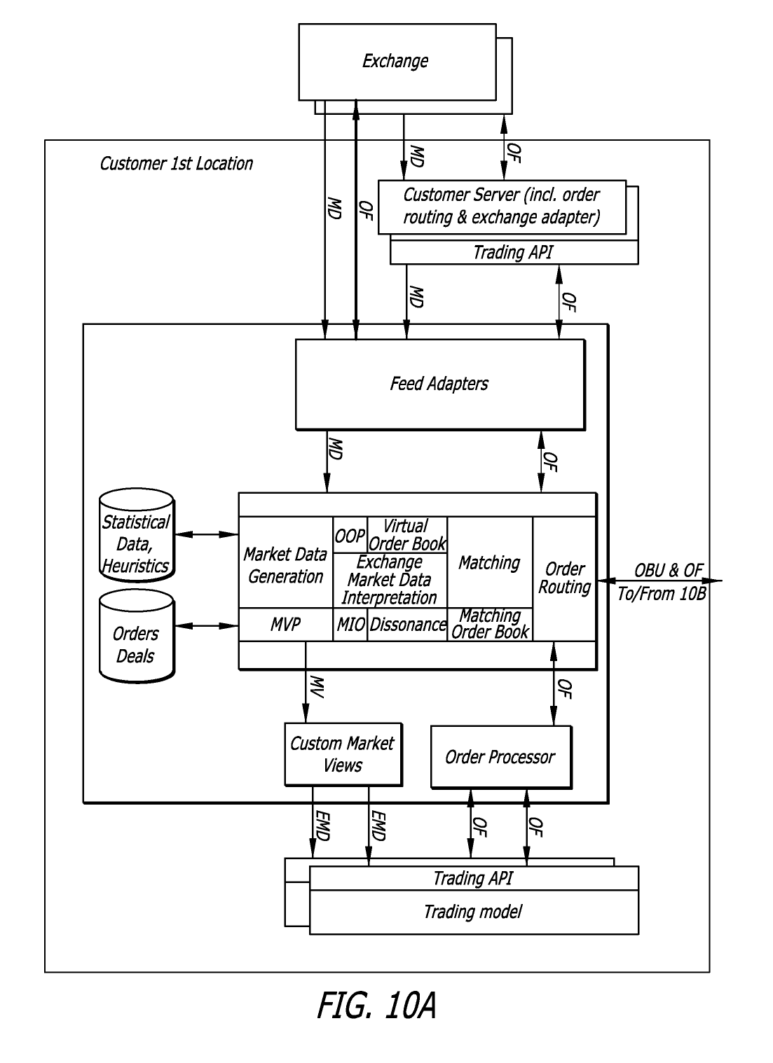

FIG. 9 shows components of the ARM architecture having a separate ARM Engine in each region and the logical connections not only between the different regions but also within each region (including its associated Exchanges and Clients). Components represent processing modules. They maintain and control specific data structures and implement functionality expressed through interfaces with the outside world. Components do not represent hardware; they may be implemented as software threads or processes. Logical connections are information channels that are only assumed to guarantee correct and sequential delivery of messages.

The following high-level rules apply to order matching in the ARM framework:

1. Matching (deal) can be done only by a matching component (ARM Engine or Order Processor) that has matching control over the two orders that are being matched. When a deal is done, deal confirmations are routed to the component that granted the matching control for the order (and, ultimately, to the order originator).
2. The component that has matching control of an order is responsible for filling this order based on the order's Matching Priority List.

### Routing Logic

Order submission across different exchanges is facilitated by situating routing nodes close to each region (exchange or cluster of exchanges). These routing nodes regard all components including all connected exchanges and other routing nodes as order sources. These routing nodes have additional capabilities including aggregation and internal matching and are known as Aggregation, Routing and Matching engines (‘ARM engines’).

The routing logic is greatly simplified by treating all connected components simply as order sources (that have different capabilities). Order sources could include traders, exchanges and other ARM engines. Even a data distributor component is considered as an order source.

Once the “highways” (the basic routing rules) are made simple, the logical routing capabilities can be safely made more complex without the application becoming unmanageable (e.g., orders can be routed to the destination through designated path, rerouted in whole or in part on reaching another ARM engine based on latest information; limits may also be specified as to how much be matched on particular venues).

Order Request messages may be used to request matching control for a set of orders from another component. The request is general: it includes amount requested, price limit, and may specify other filtering criteria. The target component responds with one or more specially formatted OrderSubmit messages followed by a OrderRequestDone message. The requestor responds with one or more DealDone and OrderDone messages.

When a quote has been submitted to an External Exchange (thereby transferring order control to the exchange) and a matching counter-quote appears on the internal market, ARM Engine may request momentary control of the counter-quote from the owner(s) while at the same time canceling the order on the External Exchange. After the cancel is acknowledged, ARM Engine commits the successfully cancelled amount via DealDone and OrderDone messages. (The remainder of the quote, if any, may then be resubmitted to the External Exchange.)

### Order Routing Policy

ARM engines that are close to exchanges yet distant from the trader may optionally be configured to reroute the order in case a better opportunity is found, based on the latest information available to each ARM engine as the order reaches the ARM engine. This is preferably accomplished by providing each trader's order with a set of parameters known as a ‘Routing Policy’ that includes:

Order Control Time Limit. A time after which, if there is no suitable match in the ARM engine's region, the order will continue on its Destination and Traversal Path
Order Visibility Flag. If an order is visible it may be submitted to an exchange either as an order type that is not shown to other exchange participants, such as IOC (Immediate or Cancel') or as a displayed order using order types such as GTC ('Good Till Cancel') depending on the functionality of the exchange.
Order Destination and Traversal Path. The order will be routed along the Traversal Path to the Destination component. Any component on the Traversal Path may initiate match according to the Matching Priority List. When the order reaches the Destination, any remaining unmatched amount is placed in the market.
Matching Priority List. This list contains venues (External Exchanges, ARM Engines, individual Order Processors, individual counterparties, or even individual orders) in order according to which matching will be done.

### Smart Order Routing

The described trading architecture is modular by design and is expected to evolve from merely delivering enhanced market feeds, to using the enhanced market feed information to revise certain pending orders prior to delivery to a particular exchange, to a smart order routing and internal matching product servicing multiple traders and multiple exchanges in multiple geographic regions.

In its simplest configuration, Order Flow (OF) is submitted directly to the customer server and is sent to the exchanges directly through customer's own infrastructure. All incoming market data (MD) from all exchanges and all Order Flow Reports (OFR) from all traders is preferably converted into the same internal meta-protocol used within the market data enhancer system. At least in its initial configuration, the required protocol converter (feed adapter) will be on the customer's premises and included within the market data enhancer system. However, it is contemplated that some exchanges will provide an optional data feed that has already been converted to that meta-protocol, and that at least some customers will adopt that internal meta-protocol for internal communications. Accordingly, it is contemplated that any required protocol converter may be located at the exchange and/or at a proprietary gateway between the exchange and the customers infrastructure.

The same basic enhanced market data capability can be deployed in multiple data centers, each responsible for customers in a single region. However, each such deployment acts independently of each other and does not communicate with others. Alternatively, in one contemplated future multi-region deployment, two regions share each other's Enhanced Market Data (EMD), This removes the need for customers in one region to subscribe to remote exchanges thus saving fee on market data costs.

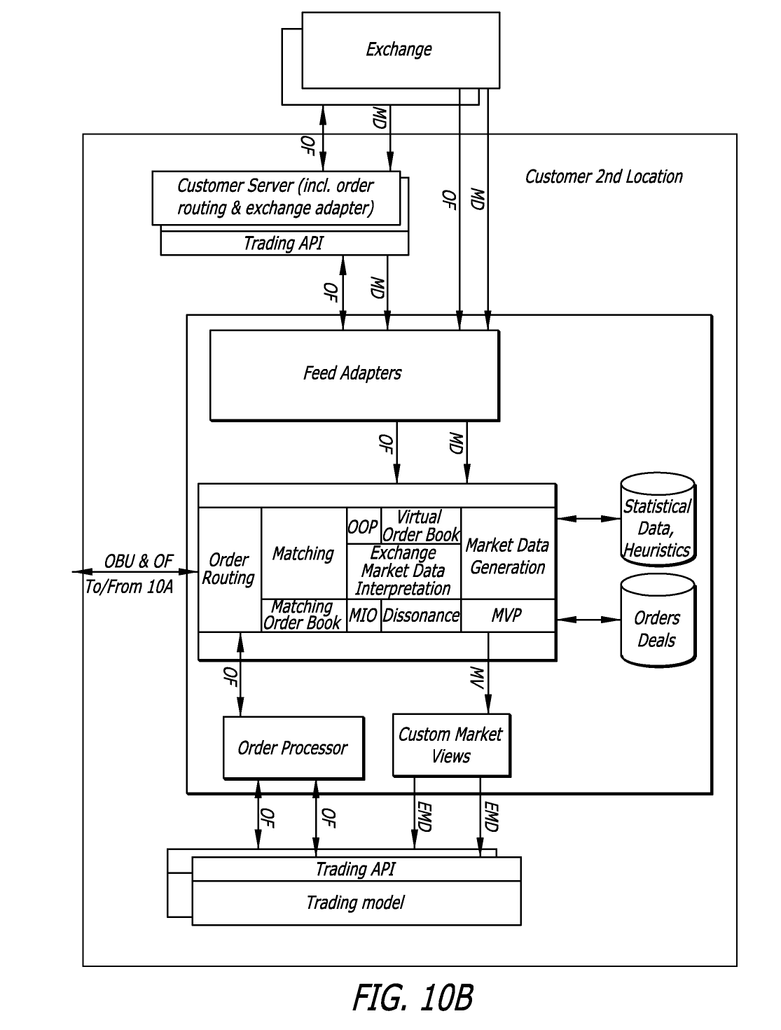

Reference should now be made to FIG. 10, which shows an embodiment of a more sophisticated multi-region deployment having a number of enhancements, not all of which will be required for all customers. Orders (including cancels and updates) from multiple internal clients (traders and/or trading automata) are routed through an internal Order Processor and forwarded to the external exchange only if a suitable internal match cannot be found by the included Matching Engine.

Particularly for customers having trading clients operating in more than one region, it is advantageous not only to provide Market Data Enhancement in each region, but also to route any Orders from a client in one region to an Exchange in another region through the affected MD Enhancers and Order Processors (and their included internal matching engines) in both regions. Accordingly, each Order Router component will preferably maintain global Routing Matrix that will contain information for bi-lateral connection between all components in the system, and will thereby be able to determine which Order Router to send the order flow to based on this Routing Matrix.

For organizations having a large number of clients and exchanges in multiple regions operating simultaneously, it is desirable that market data from a remote region be already synchronized with order flow to that region. This is preferably accomplished by having the Order Router component in each region transmit virtual order book updates (“OBU”) (in addition to order flow) to the remote Order Routers. All communication between two Order Routers will be on a single channel or socket thus synchronizing market data and order flow. Since the market data and order flow exchange will be synchronized in this stage, dissonance calculation will no longer need to be done for remote orders, and there will be no need for implied order and obscure order creation for remote orders.

In yet another contemplated enhancement, liquidity across multiple feeds from multiple exchanges may be combined into a common logical aggregated Virtual Order Book, thereby permitting certain customers to submit orders to the system that will be automatically routed to the exchange(s) with best available liquidity. To that end, the Order Router will need to be able to split the order and route it to multiple exchanges. Preferably that will include smart order routing functionality in each Order Router in the possible paths from client to the affected exchanges that takes into account not only the liquidity available and the customer's preferences, but also a heuristic/statistical analysis of historical market data from each affected exchange to select the combination of exchanges that provides best chance of execution, etc.

Each order router at the time of order submission to the next node in the traversal path will be able to predict for all downstream nodes in the traversal path what each node will do in terms of order routing and matching, which may be used to update the VOB's of the affected exchanges.

### Synthetic Orders

The disclosed architecture permits implementation of compound takes (functionality required to implement synthetic currency pairs, e.g. EUR/CHF synthesized from EUR/USD and USD/CHF) as well as those synthesized within and across other asset classes (such as basis trades and EFPs). Note that these compound orders may consist of internal legs to the ARM platform and an external leg.

Synthesized currency pairs require “compound order processing” which is implemented by requesting momentary matching control for a number of internal markets, followed (possibly) by an IOC order placed with an External Exchange, before the internal orders are committed.

Note that orders are routed to a destination on the basis of a price being available at that location and not a specific order. In this way, if an order is seen at a distant location that would match with a trader's order, an ARM engine may route the trader's order to the distant location and it would match even if the original order seen at the distant location is no longer available (perhaps because it was canceled or matched with another party) yet has been replaced by another order that fulfills the trader's requirement in whole or in part.

### In-Flight Modification of Orders

If the trading client receives market data indicating that the target opportunity has changed before receiving the order response from the venue, the order is preferably modified (or cancelled if target opportunity is gone) “in flight”. This happens even if order is still midway to the venue, or even if the new market data are received by the trading client after the venue “match time.”

In practical terms, a trading client located in New York may submit an order to a London venue (with a 40 ms one-way transmission latency) and request that the order be cancelled if the NY trading client receives any market data indicating that the target price has disappeared prior to the NY client receiving an order response from London (which takes 80 ms or longer). From the point of view of the NY trading client, the client is free to submit a new order against any NY liquidity as soon as the London target price disappears, whether it happens 1 ms or 79 ms after the order has been sent.

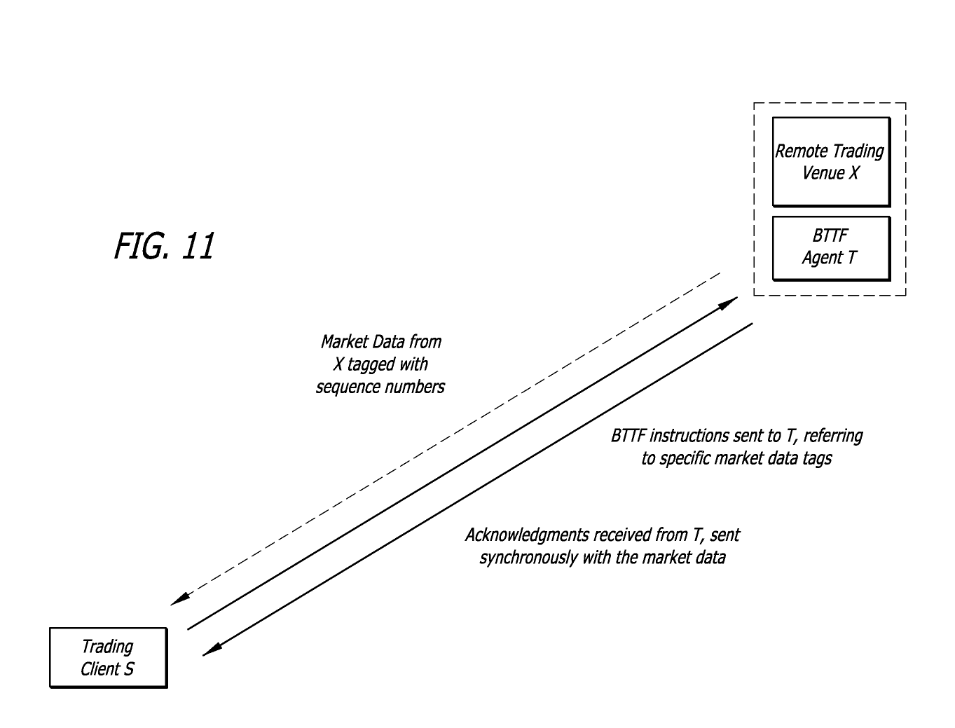

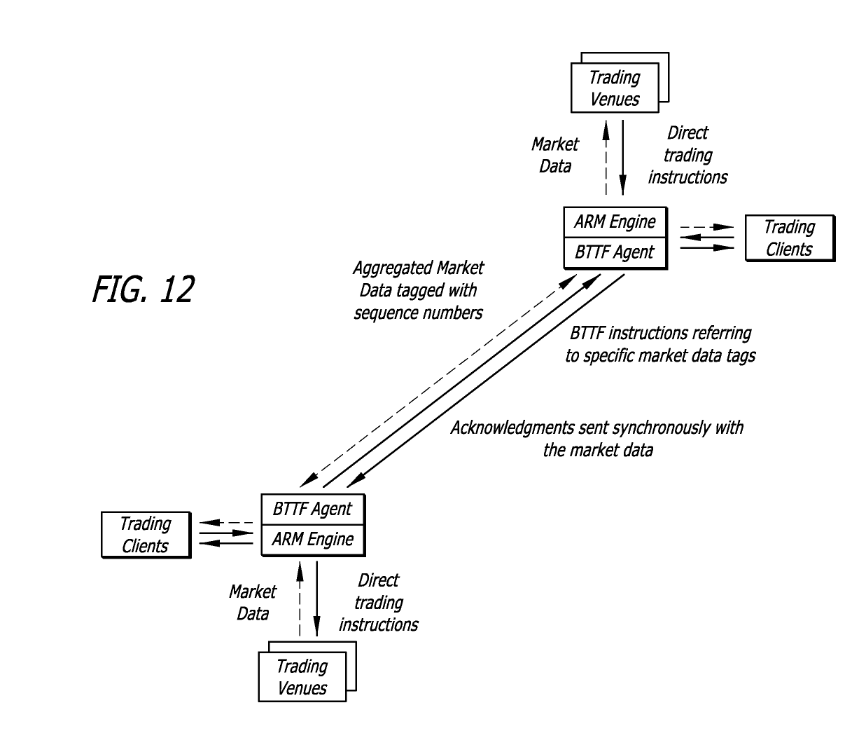

As shown in FIG. 11 and FIG. 12, a programmed digital processor (or other functionally equivalent component) is preferably collocated with the remote venue X, referred here as the BTTF Agent T. The component may be an integral part of the trading venue or it may be deployed outside of the venue (for example, by the organization that runs the trading client or by an independent third-party service company).

The BTTF Agent T can communicate with the trading client S and with the venue X. and the trading venue X considers the messages sent by the BTTF Agent (order submits, cancellations, and other trading instructions) as if they were received from the trading client S. In other words, T is acting on behalf of S. All communications (market data and order flow network messages) between the venue X and the trading client S are routed through T in a synchronous fashion (that is, the order of messages is preserved between T and S). The market data messages sent from T to S are numbered or otherwise identified in a chronological order. The trading client S may send regular trading messages to the BTTF Agent T destined to the venue X. These are passed unmodified by the BTTF Agent. The trading client S can also submit specially identified BTTF instruction messages that are examined and processed/modified by the BTTF Agent T before they are submitted to X. Each BTTF instruction refers to the last market data message received by the trading client S prior to sending the instruction.

In the most general terms, a BTTF instruction tells T to examine the history of market data updates sent from X through T to S, starting after the market data update identified in the BTTF instruction and including all of the market data updates sent from T to S up to the moment in time when T received the BTTF instruction from S. Typically, this will include all messages sent by T to S during the round-trip latency interval preceding the receipt of the BTTF instruction by T. The BTTF instruction results in a conditional submission by T of a direct trading instruction against the venue X. Specifically, in the Problem Scenario described above, the trading client S would send T a BTTF order submission instruction (for example, an IOC buy order for a specified maximum amount at a specified limit price) requesting an amount reduction, thus directing T to reduce the order amount to the least amount available at the specified limit price, as evidenced in the history of market data updates sent from T to S following the market data update identified in the BTTF instruction (if that least amount is zero—that is, if the target limit price has disappeared altogether—the order would not be submitted to X).

Upon receiving a BTTF instruction from S, the BTTF Agent T acts as instructed by S and sends an acknowledgment to the trading client S specifying the action taken (for example, the order was submitted for a specific amount). Note that the trading client S is able to track the market data and deduce the resulting action by the Agent upon receiving the acknowledgment from T that it has received and processed the BTTF instruction (without the specifics of the action by T against X).

As shown in FIG. 11, the BTTF concept can be implemented as an integral part of a trading venue (an exchange or a bank portal).

FIG. 12 shows how the BTTF concept may be implemented outside and independently of the trading venue. One advantage of such an implementation is that rather than referring simply to the limited (either in time or in depth) market data received from a single involved trading venue T, the BTTF instruction may be conditional on an enhanced proprietary version of that market data that is available to both the BTTF Agent and to the Trading Client.

In the fully implemented ARM architecture shown in FIG. 10, an ARM engine is present in each “region” (or “city”) and acts as an intermediary between trading clients in that region and all the trading venues. Market data and order flow is thereby naturally synchronized and a BTTF Agent may be built into each ARM engine. This allows a trading client or its local ARM engine to submit a BTTF instruction against the entire aggregated liquidity of a remote region, with the remote ARM engine performing the functions of a BTTF Agent versus any one venue or any specified set of venues in its region.

Those skilled in the art will doubtless recognize that many other embodiments of the invention can be constructed using some or all of the same concepts as are embodied in the described embodiments, and the legal scope of the invention is accordingly limited only by the appended claims (and any other claims that may be added by way of amendment and/or related applications), including any known or yet unknown equivalents thereof.

1. A trading system for allowing an order for a target opportunity, submitted by a trading client to a distant trading venue, to be modified while the order is in transit to the distant trading venue, wherein in instances in which the trading client receives market data indicating that the target opportunity has changed, the order is updated or cancelled.

2. A trading system for routing orders to multiple exchanges in a plurality of geographical regions, comprising first means at an origin region responsive to an original order for selecting-a destination region and for routing said order to said destination region; and second means at said destination region for receiving said order and for selecting a destination venue for executing said order; wherein said second means selects said destination venue from a plurality of available venues at said destination region only after it receives said submitted order.

3. The trading system of claim 2 wherein said first means uses aggregated market data from each of said geographical regions to select said destination region.

4. The trading system of claim 3 wherein said second means uses predicted market data from each of said available venues to select said destination venue.

5. The trading system of claim 4 further comprising: third means at said destination region for changing said submitted order before said order is submitted to the destination venue.

6. The trading system of claim 5, wherein an underlying financial instrument is changed to an equivalent financial instrument.

7. A distributed matching system, comprising: a plurality of geographically distributed matching components; means for associating a respective matching control between an individual order and a selected one of said matching components; and means for reassociating said respective matching control to a different selected one of said matching components.

8. The matching system of claim 7, further comprising: means for associating the same matching control to two order components of a compound order.

9. In a trading system in which multiple trading clients are connected to at least one remote electronic exchange through a shared market gateway that distributes market data from the exchange to the clients and transmits order data from the clients to the exchange, first means for maintaining a virtual order book data structure in which market data received from the exchange is supplemented with order data received from the clients second means for maintaining a market impact overlay data structure which includes order data received from the clients that is not yet reflected in the market data previously received from the exchange, and third means for eliminating any order data in the market impact overlay that is already reflected in market data received from the exchange, fourth means responsive to the receipt of new market data for updating the virtual order book with the new market data and the order data still remaining in the market impact overlay.

10. The trading system of claim 9, wherein a candidate order book is determined for each order in the market impact overlay, and dissonance between the different candidate order books and the most recent market data is used to determine which orders in the market impact overlay data are already reflected in the most recent market data.

11. The trading system of claim 9, further comprising an API for permitting each client to select whether market data from a particular exchange is to be enhanced with order data not yet reflected in that market data.

12. The trading system of claim 9, further comprising an API for permitting each client to select a preferred style for receiving market data from more than one exchange.

13. A trading system for allowing an order for a target opportunity, submitted by a trading client to a distant trading venue, to be modified while the order is in transit to the distant trading venue, wherein in instances in which the trading client receives market data indicating that the target opportunity has changed, the order is UPDATED OR CANCELLED.
